(19) United States
(12) Patent Application Publication
(10) Pub. No.: US 2003/0151519 A1
(43) Pub. Date: Aug. 14, 2003

(54) Guide assembly for helping and guiding blind persons

(76) Inventor: Maw Gwo Lin, Yungkang City (TW)

Correspondence Address: CHARLES E. BAXLEY, 5th Floor, 59 John Street, New York, NY, 10038, US

(21) Appl. No.: 10/074,802

(22) Filed: Feb. 14, 2002

(51) Int. Cl. H04Q 1/00

(52) U.S. Cl. 340/825.19; 340/407.1

(57) ABSTRACT

A guide device for helping and guiding blind persons includes an image taking device for taking image signals, a treating device for receiving the image signals and for treating the image signals and an actuating device for engaging onto the blind persons, and for receiving signals from the treating device, and for being actuated to act onto the blind persons. The guide device may thus be attached onto the blind persons and may act onto the blind persons for helping and guiding most of the blind persons to go out without the help from the specially trained dogs.

### BACKGROUND OF THE INVENTION

1. Field of the Invention

The present invention relates to a guide assembly and more particularly to a guide assembly for helping and guiding blind persons to go out without the help from the specially trained dogs.

2. Description of the Prior Art

Typically, the blind persons may not go out without the help from the other persons. Some of the blind persons may go out with the help from the specially trained dogs. However, it may take a long time to train the specially trained dogs, such that the number of the specially trained dogs is always not enough for helping and guiding most of the blind persons. Accordingly, only few blind persons may go with the help from the specially trained dogs.

The present invention has arisen to mitigate and/or obviate the afore-described disadvantages of the conventional guide devices for helping and guiding blind persons.

### SUMMARY OF THE INVENTION

The primary objective of the present invention is to provide a guide assembly for helping and guiding most of the blind persons to go out without the help from the specially trained dogs.

In accordance with one aspect of the invention, there is provided a guide assembly for helping and guiding blind persons, the guide assembly comprising an image taking device for taking image signals, a treating device for receiving the image signals from the image taking device and for treating the image signals, and an actuating device for engaging onto the blind persons, and for receiving signals from the treating device, and for being actuated to act onto the blind persons. The guide assembly may thus be attached onto the blind persons and may act onto the blind persons for helping and guiding most of the blind persons to go out without the help from the specially trained dogs. Many or most of the blind persons may thus go out freely without the help from the other persons or without the help from the specially trained dogs that may not be easily and quickly trained.

The image taking device includes a camera for taking the image signals. The image taking device further includes at least one processor device coupled to the camera for processing the image signals.

The image taking device further includes a memory coupled to the processor device for storing the signals from the processor device.

The image taking device further includes an output member for outputting the signals thereof to the treating device, the treating device includes a receiver device for receiving the signals from the image taking device.

The treating device further includes a transformer device coupled to the receiver device for receiving and transforming the signals from the receiver device.

The treating device further includes a current generator coupled to the transformer device for being actuated by the transformer device to generate a current signals.

The actuating device includes a plurality of actuators arranged in a matrix shape for act onto the blind persons.

The actuators each includes a coil, and a core slidably engaged in the coil and actuated by the coil to act onto the blind persons.

The actuating device includes a plurality of conductors arranged in a matrix shape and engaged onto the blind persons for act onto the blind persons.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view showing the elements of a guide assembly in accordance with the present invention;

FIGS. 2, 3 are perspective views illustrating the attachment of the guide assembly onto the blind person;

FIG. 4 is a top plan view illustrating the attachment of the guide assembly onto the blind person;

FIG. 5 is a side plan view illustrating the attachment of the guide assembly onto the blind person;

FIG. 6 is a block diagram illustrating the members or parts of an image taking device of the guide assembly;

FIG. 7 is a block diagram illustrating the members or parts of a signal processing or treating device of the guide assembly;

FIG. 8 is a block diagram illustrating the members or parts of an actuating device of the guide assembly; and

FIG. 9 is a block diagram illustrating the operation of the guide assembly.

### DETAILED DESCRIPTION OF THE PREFERRED EMBODIMENT

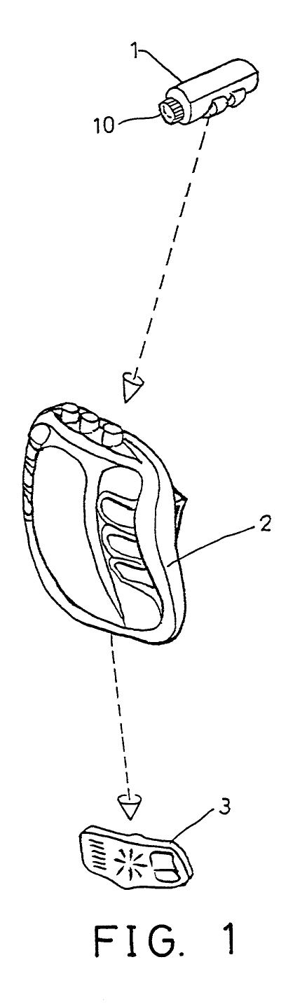

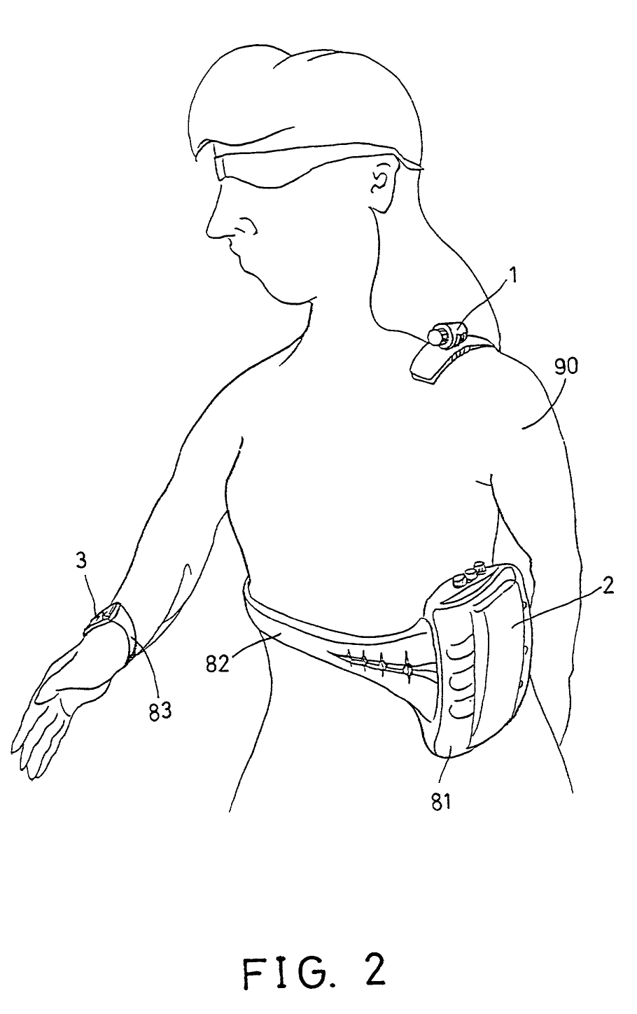

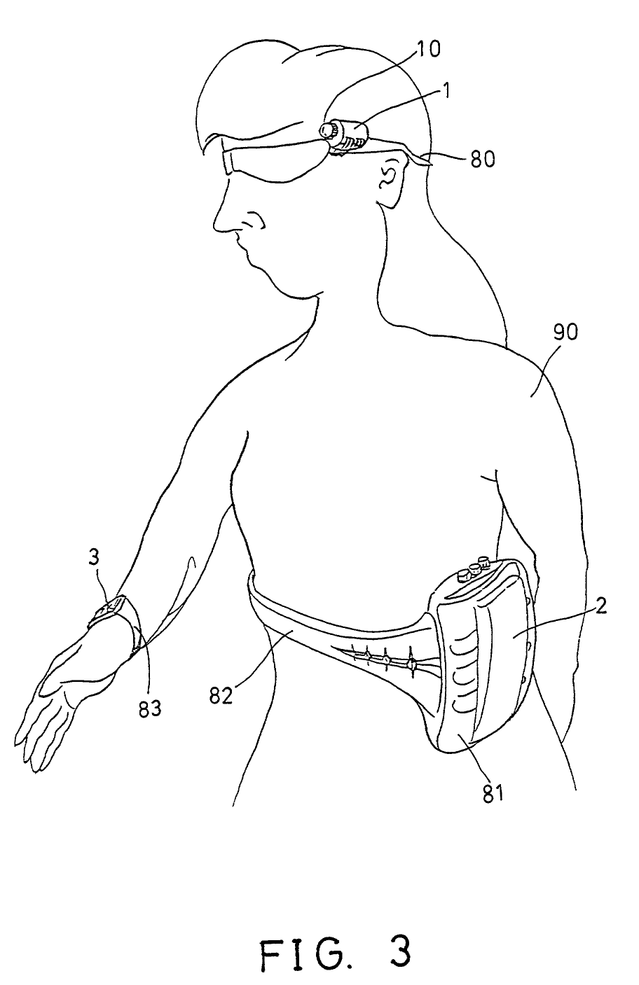

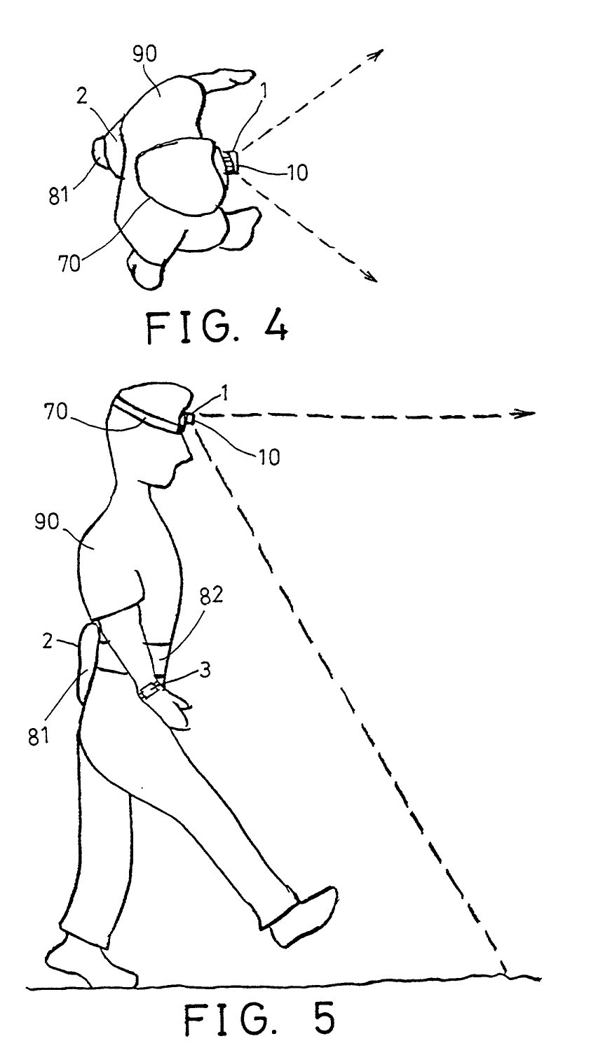

Referring to the drawings, and initially to FIGS. 1-5, a guide assembly for helping and guiding blind persons in accordance with the present invention comprises an image taking device 1 that may be attached, for example, onto the head of the blind person or the user 90 with a fastening strap 70 (FIGS. 4, 5), or with an eyewear member 80 (FIG. 3). The image taking device 1 includes a camera 10 for taking the images or for photographing purposes or for taking or grabbing image signals. The guide assembly further includes a signal processing or treating device 2 for receiving the signals from the image taking device 1 and for treating or processing the signals and for sending out the other signals to an actuating device 3 of the guide assembly. The signal processing or treating device 2 may be attached, for example, onto the waist portion of the user 90 with a fastening strap 82 and/or with a bag 81. The actuating device 3 may be attached, for example, onto the wrist portion of the user 90 with a fastening strap or band 83 or the like.

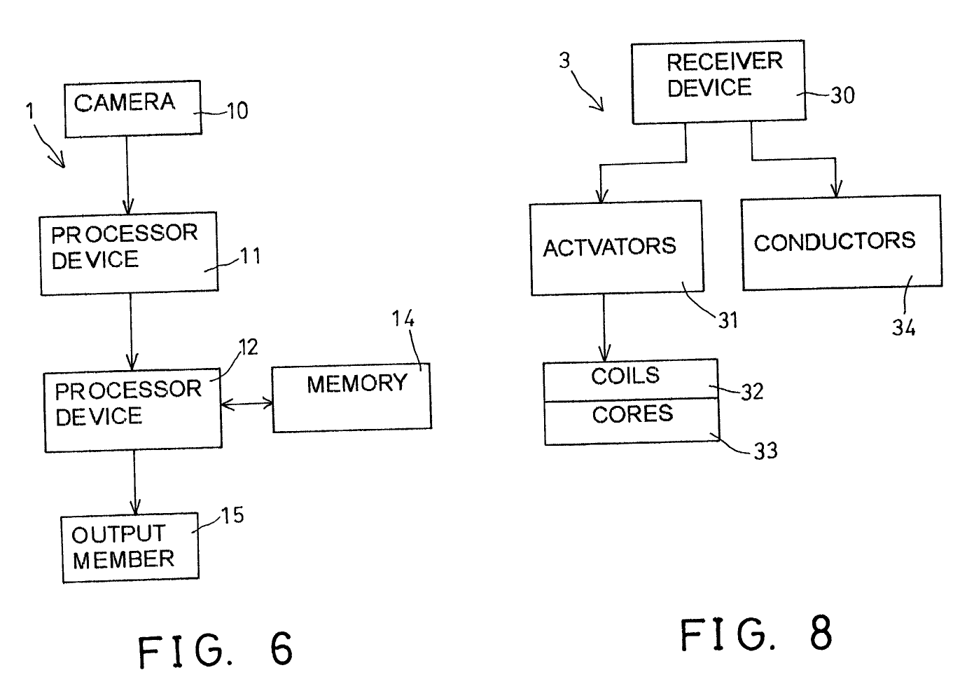

Referring next to FIG. 6, the image taking device 1 includes a camera 10 for taking the images or for photographing purposes or for taking or grabbing image signals, a first processor device 11 coupled to the camera 10 for receiving the image signals from the camera 10, a second processor device 12 coupled to the first processor device 11 for processing or treating or formatting the image signals from the first processor device 11 into the other formatted signals, such as the analog signals, or the like. The image taking device 1 further includes a memory 14 coupled to the second processor device 12 for storing the formatted signals, and further includes an output member 15 coupled to the second processor device 12 for outputting or for sending out the formatted signals to the signal processing or treating device 2.

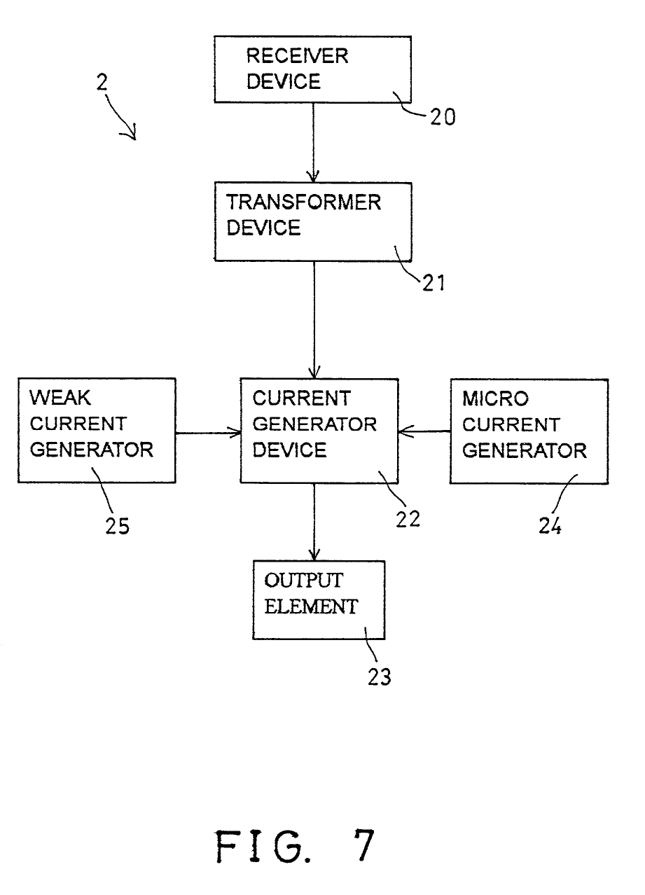

Referring next to FIG. 7, the signal processing or treating device 2 includes a receiver device 20 for receiving the signals from the output member 15 of the image taking device 1, a transformer device 21 coupled to the receiver device 20 for treating or processing or transforming the signals from the receiver device 20 into the other actuating signals, and a current generator device 22 coupled to the transformer device 21 for being actuated by the actuating signals from the transformer device 21 to generating current signals. For example, the current generator device 22 may include a micro current generator 24 and/or a weak current generator 25 for generating various kinds of current signals. The signal processing or treating device 2 further includes an output element 23 coupled to the current generator device 22 for receiving the current signals from the current generator device 22 and for sending out the signals to the actuating device 3 of the guide assembly.

Referring next to FIG. 8, the actuating device 3 includes a receiver device 30 for receiving the signals from the output element 23 of the signal processing or treating device 2, and one or more actuators 31 coupled to the receiver device 30 for being actuated by the signals from the receiver device 30. For example, the actuators 31 may be the solenoid devices, and may be arranged in a matrix shape, and may each include a core 33 slidably engaged in a coil 32 and actuated by the coil 32 to actuate onto the blind persons or the users 90, when the coils 32 are energized. The cores 33 of the actuators 31 may thus be arranged in the matrix shape and may be actuated to generate the typical matrix spots that may be touched or read by the blind persons.

The actuating device 3 may simultaneously or alternatively include a number of conductors 34 coupled to the receiver device 30 for being actuated by the signals from the receiver device 30. For example, the conductors 34 may be arranged in a matrix shape, and may be actuated to generate such as the currents or the pulse signals to actuate onto the skin of the blind persons or the users 90, and/or to be felt or read by the blind persons.

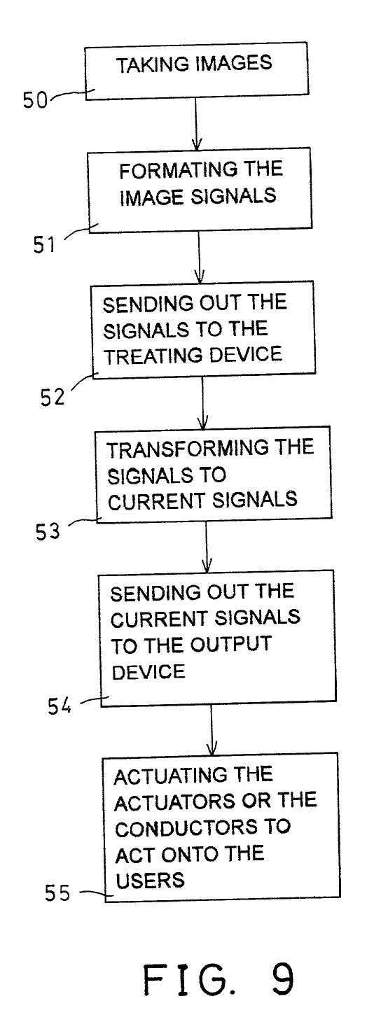

In operation, as shown in FIG. 9, the camera 10 of the image taking device 1 may be used to take images 50, the processor devices 11, 12 of the image taking device 1 may be used to treat or process or format 51 the image signals, the output member 15 of the image taking device 1 may then be used to send out 52 the signals to the treating device 2. The transformer device 21 of the treating device 2 may then be used to transform 53 the signals to current signals which may be sent out 54 to the actuating device 3. The actuating device 3 may then be actuated 55 to act onto the users. The guide assembly may be attached onto many or most of the blind persons, and may thus benefit most of the blind persons.

Accordingly, the guide assembly in accordance with the present invention may be used for helping and guiding most of the blind persons to go out without the help from the specially trained dogs.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A guide assembly for helping and guiding blind persons, said guide assembly comprising:
an image taking device for taking image signals,
a treating device for receiving the image signals from said image taking device and for treating the image signals, and
an actuating device for engaging onto the blind persons, and for receiving signals from said treating device, and for being actuated to act onto the blind persons.

2. The guide assembly according to claim 1, wherein said image taking device includes a camera for taking the image signals.

3. The guide assembly according to claim 2, wherein said image taking device further includes at least one processor device coupled to said camera for processing the image signals.

4. The guide assembly according to claim 3, wherein said image taking device further includes a memory coupled to said at least one processor device for storing the signals from said at least one processor device.

5. The guide assembly according to claim 1, wherein said image taking device includes an output member for outputting the signals thereof to said treating device, said treating device includes a receiver device for receiving the signals from said image taking device.

6. The guide assembly according to claim 5, wherein said treating device further includes a transformer device coupled to said receiver device for receiving and transforming the signals from said receiver device.

7. The guide assembly according to claim 6, wherein said treating device further includes a current generator coupled to said transformer device for being actuated by said transformer device to generate a current signals.

8. The guide assembly according to claim 1, wherein said actuating device includes a plurality of actuators arranged in a matrix shape for act onto the blind persons.

9. The guide assembly according to claim 8, wherein said actuators each includes a coil, and a core slidably engaged in said coil and actuated by said coil to act onto the blind persons.

10. The guide assembly according to claim 1, wherein said actuating device includes a plurality of conductors arranged in a matrix shape and engaged onto the blind persons for act onto the blind persons.
